(19) United States
(12) Patent Application Publication
(10) Pub. No.: US 2017/0373634 A1
(43) Pub. Date: Dec. 28, 2017

(54) MULTIPLE FUNCTION MICROSTRUCTURE WITH LOTUS AND LIGHT TRAPPING EFFECTS

(71) Applicant: NATIONAL CHENG KUNG UNIVERSITY, TAINAN CITY (TW)

(72) Inventors: SEN-YUNG LEE, TAINAN CITY (TW); CHO-YIN LEE, TAINAN CITY (TW)

(21) Appl. No.: 15/193,213

(22) Filed: Jun. 27, 2016

(51) Int. Cl. H02S 40/10; H02S 40/20

(52) U.S. Cl. CPC H02S 40/10; H02S 40/20

(57) ABSTRACT

A multiple function microstructure with lotus and light trapping effects includes plural triangular walls with same and different heights and having a triangular cross section and arranged apart or staggered with one another, and a surface layer, a middle layer having zero to plural layers, and a bottom layer. The bottom layer and one of the other layers constitute a closed space to form an air spring, so that droplets can be bounced and separated from the surface of the microstructure. Each triangular wall has a cross section substantially in a smooth upwardly convex curve to prevent droplets from cracking while dropping. The microstructure selectively made of a hydrophobic material provides lotus and light trapping effects, and the microstructure selectively made of an oleophobic material provides a superoleophobic effect, and the surface of the microstructure may be coated with various type of chemical materials for different applications.

### FIELD OF THE INVENTION

The present invention relates to a multiple function microstructure with lotus and light trapping effects, and more particularly to the microstructure having a plurality of triangular walls with a triangular cross section and arranged with an interval apart from one another or staggered with one another, and with a surface made of a hydrophobic material and having a light trapping effect.

### BACKGROUND OF THE INVENTION

Environmental protection and clean energy are very important issues around the world, and solar power generation is one of the major clean energy power generations. As to solar devices such as solar panels, the surface of the solar panel is often polluted or contaminated, and the power generation efficiency is lowered significantly. In the meantime, sunlight is reflected from the surface of the solar panel, and thus the power generation efficiency is lowered further.

Lotus effect refers to a phenomenon of a droplet dropping from a certain height onto the surface, wherein a static contact angle between the droplet and the solid surface is greater than 150°, and the surface has a property of bouncing and rolling the droplet to achieve a self-cleaning function. If the surface has a static contact angle greater than 150° but does not have the property of bouncing and rolling the droplet, then such surface is called static superhydrophobic.

After a lotus leaf surface is observed through a scanning electron microscope (SEM), the lotus leaf surface has a stud with a size of approximately 20 μm and a layer pitch having fine hair of hundreds of nanometers formed on epidermal cells at the pitch of the stud and covering a layer of wax crystal made of a hydrophobic material. When a droplet is situated on the lotus leaf surface, a high contact angle in a spherical shape is formed, so that the lotus leaf surface is superhydrophobic. When the droplet falls onto the lotus leaf surface, the pitch covered by the fine hair of hundreds of nanometers contains air, so that the lotus leaf surface will not be wet, and the droplet will bounce. If the lotus leaf is tilted by an angle, the droplet will roll on the lotus leaf surface, so that dust and dirt attached onto the lotus leaf surface will be carried away to achieve the self-cleaning effect.

The traditional method of manufacturing a hydrophobic material structure on a surface of an object mainly adopts the bionic concept and uses a micro-electro-mechanical system (MEMS) to manufacture a stud-shaped structure on a lotus leaf like surface, and the surface roughness is enhanced to reduce the contact area between the droplet and the top surface of the object, so as to increase the contact angle of the surface of the object. However, the traditional method has the following drawbacks:

1. The conventional MEMS method manufactures a rough surface of a stud-shaped structure on a material directly and it is unable to duplicate the nano hair on the epidermal cell of the stud, so that the structure is superhydrophobic when it remains still, but the stud-shaped structure is an open structure, and the air between the studs flows freely. When a water droplet falls from a certain height onto the stud-shaped structure, the water droplet will squeeze out the air between the studs, so that the stud-shaped structure is wetted and the hydrophobic material is lost. As a result, the droplet cannot bounce or roll, and the self-cleaning function is disabled. Such structure fails to provide the lotus effect.

As disclosed in U.S. Pat. Publication No. 2008/0014410, entitled “Oriented Polymeric Articles and Method”, FIG. 22 of this patent shows a structure having triangular walls of different heights and these triangular walls are parallel triangular walls, and the structure is an open structure. When the water droplet falls from a certain height onto a surface of the structure, the water droplet still will squeeze out the air between the parallel triangular walls, so that the surface of the structure is wetted and the hydrophobic material on the surface is lost. As a result, the droplet cannot bounce or roll, and the structure fails to provide the lotus effect.

2. Even though a natural lotus surface structure may be duplicated, the structure is still an independent stud-shaped structure, and its shear resistance and pressure resistance are insufficient. The stud-shaped structure will be damaged and disabled by a slight transverse force or longitudinal force. If the stud-shaped superhydrophobic structure is made of a material into a film like a sticker and fixed on a surface of an object, the stud-shaped structure has a weak strength, and the stud-shaped structure may be damaged easily in the manufacturing process.

3. The natural lotus surface structure is an independent stud-shaped structure, so that the light is reflected downwardly to cause a low light trapping effect, and such structure is inapplicable to solar panels.

As disclosed in U.S. Pat. Publication No. 2010/0112286 entitled “Superhydrophobic Surfaces”, a first shape 346 and a second shape 356 as shown in FIG. 6a and a higher ordered shape 456 and a lower ordered shape 446 as shown in FIG. 6b show structures with different heights and without air circulation, wherein, both second shape 356 and higher ordered shape 456 as shown in FIGS. 6a and 6b respectively are studs, and both first shape 346 and lower ordered shape 446 as shown in FIGS. 6a and 6b respectively are of equal heights and enclosed into a wall structure without air circulation between the walls, and such structure has the following features and drawbacks:

1. The stud-shaped structure may be damaged easily to lose its superhydrophobic property:

When the droplet remains still on the stud of the structure surface, the contact area between the droplet and the structure surface is small, so that the structure is superhydrophobic as long as the structure is made of a hydrophobic material. However, the stud structure is very similar to the aforementioned studs of the lotus leaf structure having insufficient shear resistance and pressure resistance, and thus the structure may be damaged to lose its superhydrophobic property easily. When the droplet falls onto a structure surface with equal heights and without air circulation between the enclosing units, the droplet has a contact angle greater than 150° as shown in FIG. 2b, but the sliding angle is very large, so that the droplet cannot roll on the solid surface (similar to the case of a droplet situated on a grid, and thus such structure does not have the superhydrophobic effect.

2. This structure has a low lotus effect:

In U.S. Pat. Publication No. 2010/0112286, a design of an air cavity without air circulation between units of the structure is disclosed, so that when a droplet falls onto a surface of the structure, air bounces, but the structure cannot prevent the droplet from breaking or cracking, and the cracked droplet enters into the air cavity to wet the structure and damage the hydrophobic material. This structure does not have any design of reducing the kinetic energy of the droplet whatsoever. After the droplet with relatively large kinetic energy falls onto the air cavity, and the droplet falling into the middle of the cavity drops to the bottom of the air cavity quickly to squeeze out the air in the cavity, so as to wet the structure and damages the hydrophobic material. Although the design disclosed in U.S. Pat. Publication No. 2010/0112286 has a better superhydrophobic effect than the pure stud-shaped structure, the falling height of the droplet is small, and thus the lotus effect is low.

3. This structure has no light trapping effect:

The structure cannot reflect or reflect light downward, and thus cannot provide a light trapping effect.

In summation, the conventional stud-shaped structure comes with a large contact angle, but has a low lotus effect and a low light trapping ability.

### SUMMARY OF THE INVENTION

In view of the aforementioned problems, it is a primary objective of the present invention to overcome the aforementioned problems by providing a multiple function microstructure with lotus and light trapping effects, particularly a microstructure having a main body made of a transparent and hydrophobic material, and each unit is comprised of a plurality of triangular walls with same and different heights and a triangular cross section, and the triangular walls are arranged apart from one another or staggered with one another, and a surface layer, a middle layer having zero to several layers, and a bottom layer, wherein the surface layer is just a straight line, and the middle layer and the surface layer constitute an open or closed space, and the bottom layer and one of the other layers constitute a closed space; and the cross section of the top of the triangular wall is substantially a smooth upwardly convex curve.

All triangular walls jointly provide a fore for supporting and pushing the droplet upward to reduce the kinetic energy of the falling droplet. The bottom layer has a portion with a closed space to provide the effect of an air spring for bouncing the droplet and separating the droplet from the surface of the microstructure. In the meantime, the surfaces of the paired triangular walls refract and reflect light downwardly to each other to achieve a light trapping effect.

In summation of the description above, the present invention has the following advantages and effects:

1. The top of the triangular wall of the present invention is substantially a smooth upwardly convex curve, so that when the droplet falls onto the main body, the droplet will not crack easily to form smaller droplets to wet the main body, wherein the surface layer is a linear structure. Therefore, the contact area of the droplet is very small, and a superhydrophobic surface is formed. The triangular walls arranged apart from each other or staggered with one another are jointly provided for supporting and pushing the droplet upward. As the droplet approaches the bottom layer, the quantity of triangular walls increases, and the pitch decreases gradually, so as to reduce the kinetic energy of the falling droplet, and the closed space of the bottom layer provides an effect of an air spring for bouncing the droplet and separating the droplet from the surface of the microstructure.

2. The structure of the present invention is made of a transparent and hydrophobic material, and the invention not just provides the lotus effect only, but also reflects and refracts light downwardly from the surfaces of the paired triangular walls to achieve a light trapping effect.

3. If the microstructure with the lotus and light trapping effects is applied for generating power by a solar panel, the efficiency of the solar power generation will be improved. In addition, the present invention may also be applied to greenhouse agriculture and any other occasion that requires lighting.

4. The structure of the present invention is comprised of a plurality of triangular walls staggered with one another and being elastic, and the structural strength of the structure is much greater than the natural bump type lotus structure, so that when the structure of the present invention is attached onto a surface of a product, the product will not be damaged easily.

5. The mold for producing the structure of the present invention may be formed by cutting, and a product may be mass produced in a large area by the method of transferring the microstructure, and the microstructure may be formed on the surface of an object easily or manufactured into a film to be attached onto a surface of a product.

6. If the microstructure of the present invention is made of an oleophobic material, the microstructure will be superoleophobic. Different chemical materials may be coated onto the surface of the microstructure as needed surface. In addition, the chemical material in the structure of the present invention is also protected by this structure. Obviously, the present invention may be applied extensively in different technical areas.

### BRIEF DESCRIPTION OF THE DRAWINGS

FIG. 1 is a schematic view of a double-layer structure formed in accordance with the present invention;

FIG. 2 is a schematic view of a three-layer structure formed in accordance with the present invention, wherein a closed space is defined between a middle layer and a surface layer of the three-layer structure;

FIG. 3 is a schematic view of a three-layer structure formed in accordance with the present invention, wherein an open space is defined between a middle layer and a surface layer of the three-layer structure;

FIG. 4 is a schematic view of a four-layer structure formed in accordance with the present invention;

FIG. 5a is a schematic view of a top of a triangular wall formed into a curved structure in accordance with the present invention;

FIG. 5b is a schematic view of a triangular wall configured with a height different than another triangular wall in accordance with the present invention;

FIG. 6 is a schematic view of an optical path of a light reflected and refracted downwardly among triangular walls when the light is projected onto a multiple microstructure of the present invention;

FIG. 7 is a schematic view of an action of a triangular wall supporting a drop in accordance with the present invention

FIG. 8 is a schematic view of a static contact angle measured in an experiment in accordance with the present invention; and

FIG. 9 is a photo of an experiment of a droplet falling onto a structure and bouncing from the structure in accordance with the present invention.

### DESCRIPTION OF THE PREFERRED EMBODIMENTS

The technical characteristics, contents, advantages and effects of the present invention will be apparent with the detailed description of a preferred embodiment accompanied with the illustration of related drawings as follows.

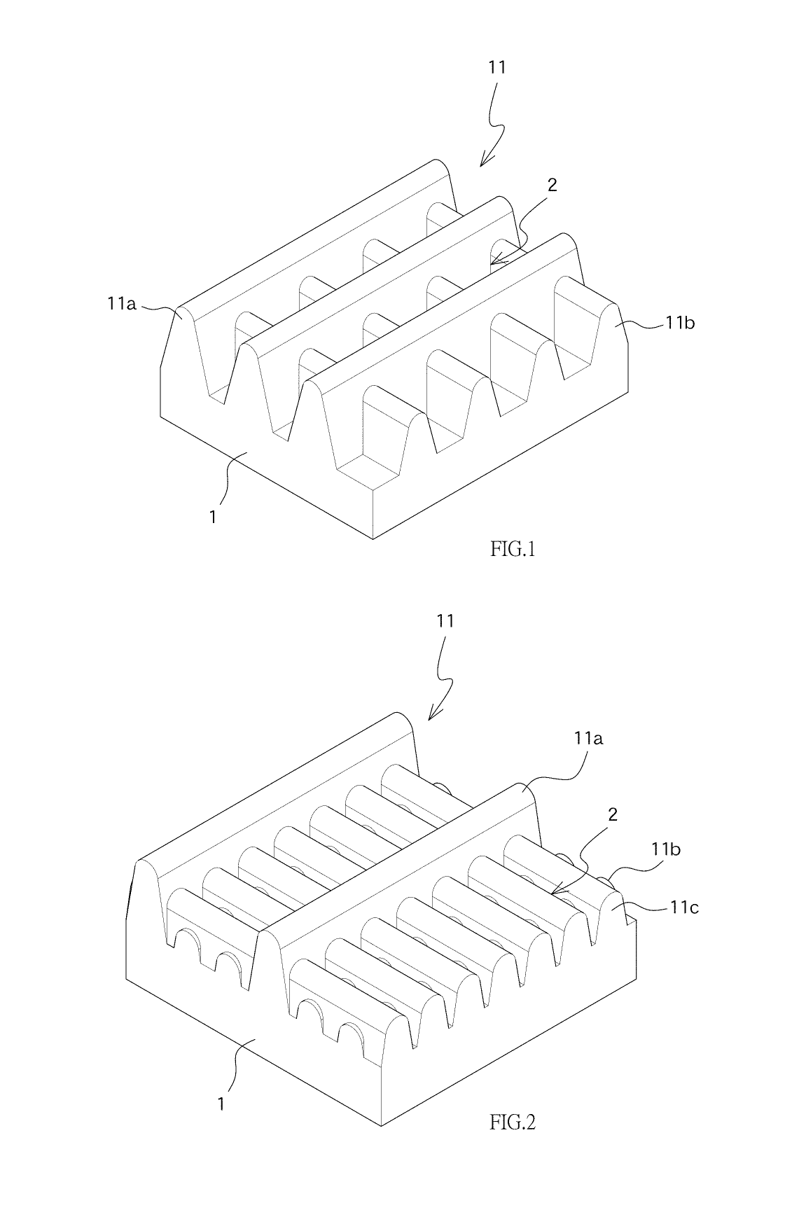

With reference to FIGS. 1 to 4 for a multiple function microstructure with lotus and light trapping effects in accordance with the present invention, the microstructure comprises the following elements:

A main body 1 is comprised of a plurality of triangular walls 11 with same and different heights and a triangular cross section and arranged apart from one another or staggered with one another and including a surface layer, a middle layer with zero to plural layers, and a bottom layer arranged sequentially from a high position to a low position bottom, and the cross section of the top of the triangular wall is substantially a smooth upwardly convex curve, preferably a smooth arc in this preferred embodiment.

Wherein, the triangular wall 11a of the greatest height forms the surface layer, and the triangular wall 11b of the smallest height forms the bottom layer, and the top of the triangular wall 11a of the greatest height is a linear structure constituting a superhydrophobic surface, and a closed space 2 is defined between a plane extended from the top of the triangular wall 11b of the smallest height and another triangular wall 11.

In a preferred embodiment as shown in FIG. 1, a double-layer structure just having a surface layer and a bottom layer comprises two triangular walls 11a, 11b with different heights and staggered with one another.

In another preferred embodiment as shown in FIG. 2, a three-layer structure having a surface layer, a middle layer, and a bottom layer comprises three triangular walls 11a, 11b, 11c of different heights and staggered with one another, and the triangular wall 11c of the middle layer and the triangular wall 11a of the surface layer are staggered with each other, so that a closed space is formed between the middle layer and the surface layer.

In another preferred embodiment as shown in FIG. 3, a three-layer structure having a surface layer, a middle layer, and a bottom layer comprises three triangular walls 11a, 11b, 11 of different heights and arranged apart from one another and staggered with one another, and the triangular wall 11c of the middle layer and the triangular wall 11a of the surface layer are parallel to one another, so that an open space is formed between the middle layer and the surface layer.

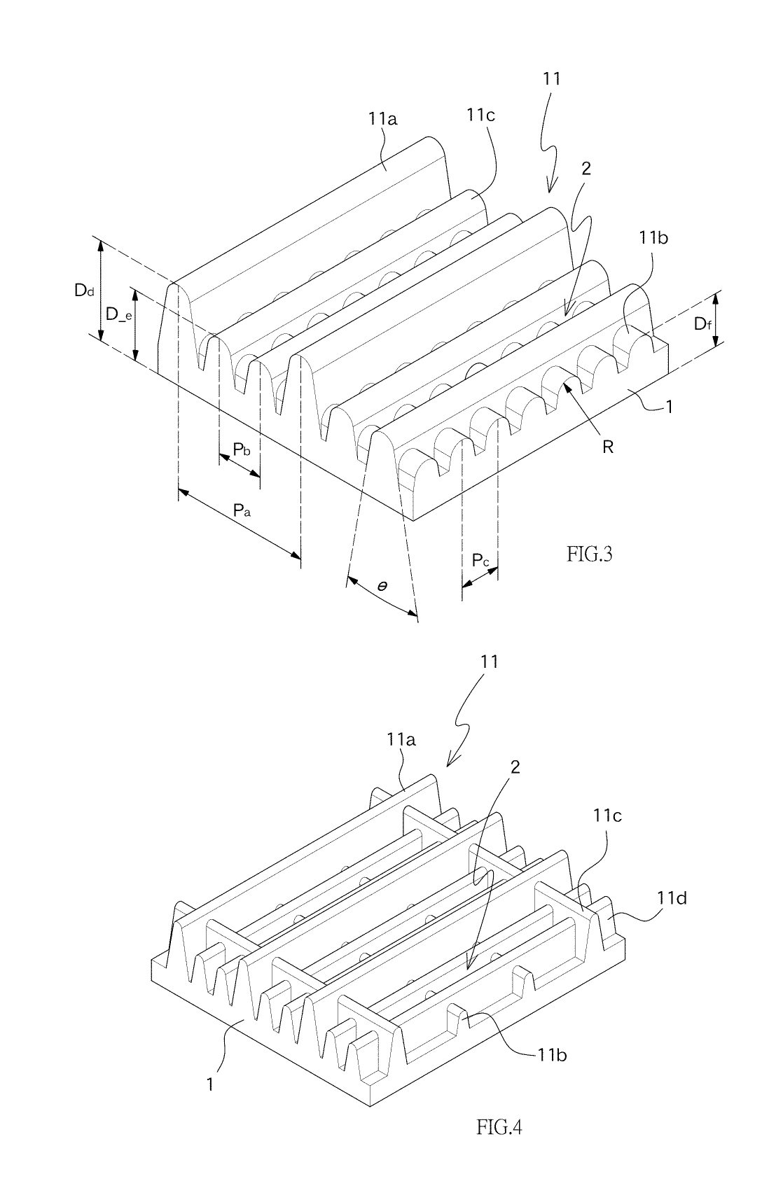

In another preferred embodiment as shown in FIG. 4, a four-layer structure having a surface layer, two middle layers, and a bottom layer comprises four triangular walls 11a, 11b, 11c, 11d of different heights and arranged apart from one another and staggered with one another.

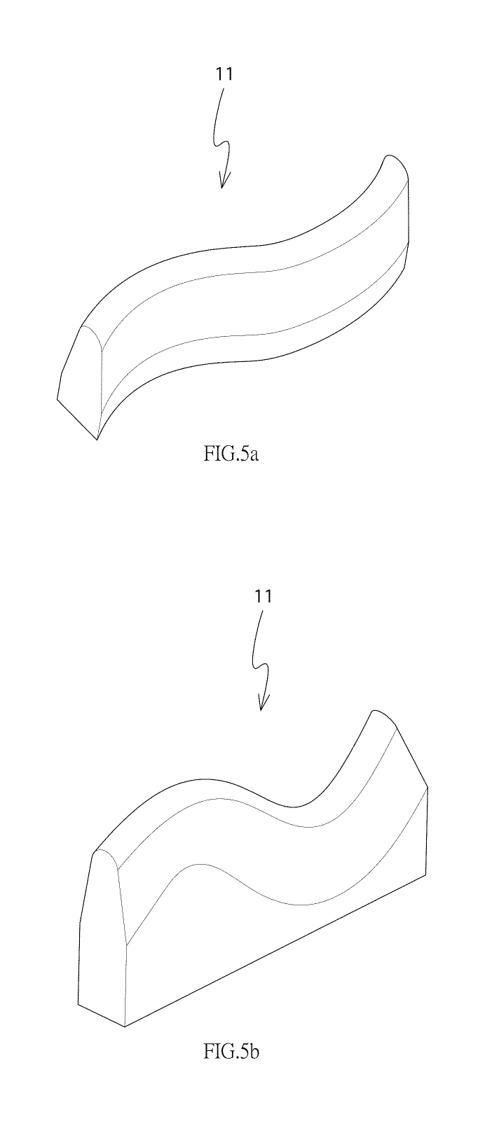

In the preferred embodiments as shown in FIGS. 1 to 4, the top of the triangular wall 11 is basically a straight line and of the same height. In another preferred embodiment as shown in FIG. 5a, the triangular wall 11 is a curved structure. In FIG. 5b, the tops of the triangular walls 11 are configured with different heights. In other words, the triangular wall 11 of the present invention allows a slight change of linearity and height.

With reference to FIGS. 2 to 4 for the schematic views of a portion of the main body 1 of the present invention, the main body 1 may be extended or reduced repeatedly in actual applications, and the number of middle layers may vary to form a surface layer, a middle layer with zero to several layers, and a bottom layer.

In addition, the top view of the portion enclosed by the triangular walls of the present invention may be in a rectangular shape or in any other geometric shape.

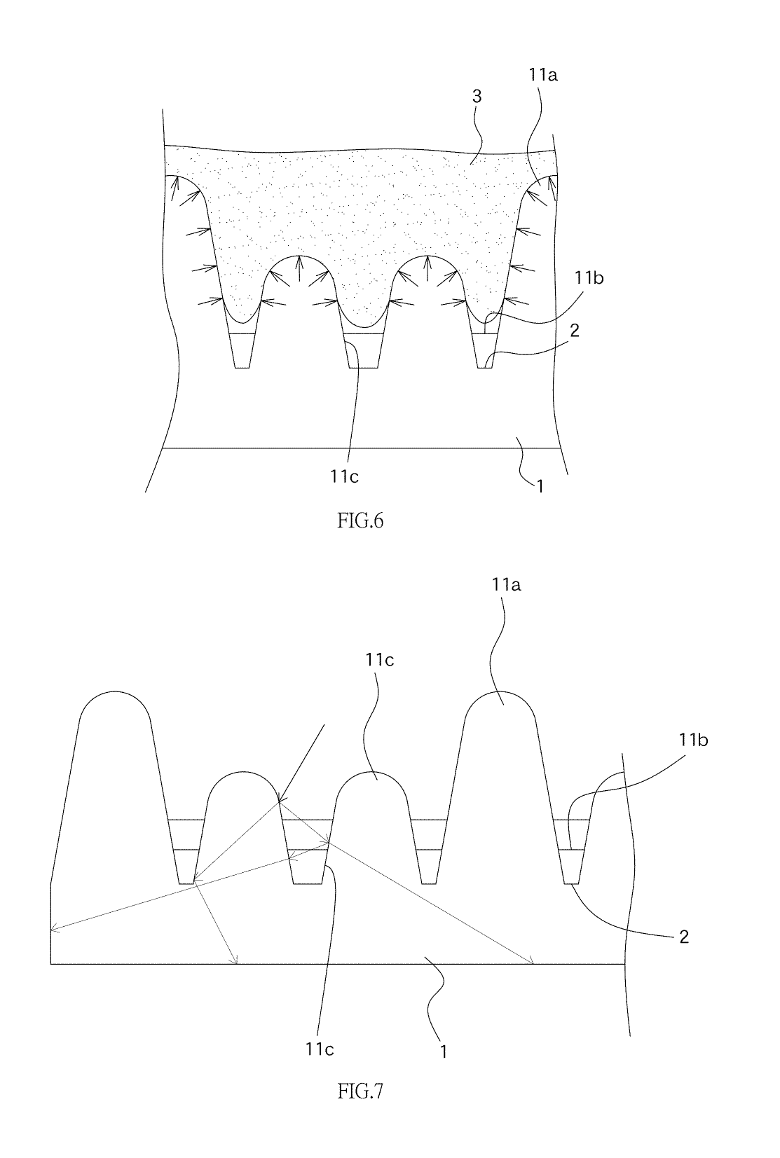

FIG. 6 shows that the triangular walls at all layers jointly provide a supporting force to support the droplet upward to reduce the kinetic energy of the falling droplet. As the height of the triangular wall decreases, the quantity of triangular walls increases, so that the pitch becomes smaller, so as to improve the effect of reducing the kinetic energy of the falling droplet. The portion of the closed space provides an effect of an air spring for bouncing the droplet and separating the droplet from the surface of the microstructure.

FIG. 7 shows an optical path of a light projected onto the microstructure, wherein the microstructure provides a light trapping effect since both reflected and refracted lights can travel downward.

It is noteworthy that if the main body 1 is made of a transparent and hydrophobic material, then the main body 1 of the present invention will have lotus and light trapping effects; if the main body 1 is made of an oleophobic material, then the main body 1 will have an oleophobic effect; and if the structure surface of the present invention is coated with different chemical materials as needed, the chemical material in the structure of the present invention is also protected by the present invention. Obviously, the present invention can be applied extensively in different technical areas.

In a structure of this preferred embodiment as shown in FIG. 3, the triangular wall 11 of this preferred embodiment has a cone angle θ, and the top of the triangular wall 11 has a radius of curvature R, and the triangular walls 11a, 11c are arranged transversally, and a first pitch Pa exists in the triangular wall 11a, and a second pitch P_b exists in the triangular wall 11c, and a distance exists between the triangular wall 11a and the triangular wall 11c. The triangular wall 11b is arranged transversally and substantially perpendicular to the triangular wall 11a and the triangular wall 11c, and a third pitch Pc exists in the triangular wall 11b. The first pitch Pa, the second pitch P_b and the third pitch Pc refer to the pitch between the triangular walls 11, wherein the mid-point of the first pitch Pa is superimposed on the mid-point of the second pitch, and the height of the triangular wall 11a is the greatest one among the heights of the triangular walls 11, and the height of the triangular wall 11b is the smallest one among the heights of the triangular walls 11. Wherein, the triangular wall 11a has a height Dd, the triangular wall 11c has a height D_e, and the triangular wall 11b has a height Df. The closed space 2A is formed between a plane extended from the top of the triangular wall 11b, the surface of the main body 1, the triangular wall 11a, and the triangular wall 11c.

In this preferred embodiment, the symbol P_{c}^{a}^{_}^{b}D_{f}^{d}^{ₑ}_θ_R shows the height, pitch, cone angle θ and radius of curvature R of the triangular wall 11a, the triangular wall 11c and the triangular wall 11b of the main body 1.

In the structure as shown in FIG. 3, the cone angle θ falls within a range from 20° to 30°; the triangular wall 11a has a height falling within a range from 12 μm to 30 μm; the triangular wall 11c has a height falling within a range from 7 μm to 20 μm; the triangular wall 11b has a height falling within a range from 4 μm to 12 μm; the radius of curvature R falls within a range from 1.25 μm to 2.25 μm; the top-layer triangular wall 11a has a first pitch Pa falling within a range from 24 μm to 36 μm; the middle-layer triangular wall 11c has a second pitch P_b falling within a range from 8 μm to 12 μm; the bottom-layer triangular wall 11b has a third pitch Pc falling within a range from 7 μm to 10 μm, and the main body 1 is manufactured according to the specification based on one of the aforementioned ranges.

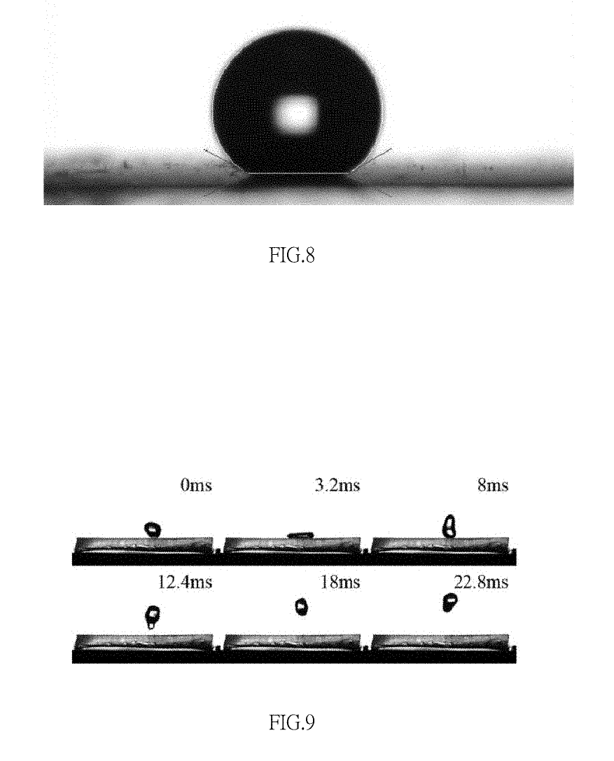

With reference to FIG. 3 for the structure, geometric shape and size of the tested main body 1 of this preferred embodiment, a test piece of the main body 1 is made of a transparent light guide material, polydimethylsiloxane (PDMS) and has an area equal to 20 mm*20 mm. In this experiment, a FTA-1000B contact angle projector is used to measure the static contact angle, and five measurements are taken to calculate the average and standard deviation. The experiment result as shown in FIG. 8 shows that the contact angle of the droplet 3 on the main body 1 is equal to 151.18±2.17° which is greater than 150°, so that the main body 1 has a superhydrophobic surface.

With reference to FIG. 9 for a photo of bouncing a droplet 3 in an experiment, when the droplet 3 falls onto the structure in accordance with a preferred embodiment of the present invention, a high-speed camera with a shooting speed of 1500 photos per second and a droplet 3 with a volume of 5 μL are used for the experiment, the droplet 3 falls freely from a height of 30 cm onto a surface of the main body 1, the collision process is observed and recorded. Experiment results show that the droplet 3 completely bounces from the surface of the main body 1, and as long as the surface of the main body 1 is tilted slightly, the droplet 3 can roll and carry dust away from the surface of the main body 1. Since the top of the triangular wall 11 is in an arc shape, the droplet 3 will not crack into smaller droplets 3 when the droplet 3 is situated at the triangular wall 11 a and the triangular wall 11c of the main body 1, and the height difference and pitch of the triangular walls 11a, 11b, 11c allow the droplet 3 to be supported jointly by the sidewalls of the triangular walls. When the droplet 3 approaches the bottom layer, the quantity of the triangular walls 11 increases, and the pitch gradually decreases. Such arrangement not just can support the droplet 3 only, but also can reduce the kinetic energy of the falling droplet 3.

As to the dust in the air, the dust generally has a particle size falling within a range from 0.001 μm to 500 μm and a mass approximately equal to 0.1 μg to 10 μg, wherein the particle with a particle size below 0.1 μm has similar properties of a molecule, so that if the particle collides with a gas molecule, a substantial free movement will occur. If the particle has a particle size falling within a range from 1 μm to 20 μm, the particle will flow with the gas easily. If the particle has a particle size greater than 20 μm, then an obvious sedimentation will occur. In the present invention, the triangular walls 11a, 11b, 11c come with different heights and the third pitch Pc is smaller than 10 μm, so that it is difficult for the dust to fall between the triangular walls 11. For a pitch smaller than 35 μm, approximately 75% of dust in the air can be isolated. For a pitch smaller than 10 μm, approximately 97% of the dust is isolated. Even if the dust is attached onto a surface of the main body 1 surface, the aforementioned self-cleaning function is capable of carrying the dust away from the surface of the main body 1 through the droplet 3.

With reference to FIG. 7 for a schematic view of an optical path of a light projected onto the main body 1 and reflected and refracted downwardly between the triangular walls 11, a vast majority of the light reflected and refracted between the triangular walls 11 travels downwardly, and it shows that the surface of the main body 1 has a light trapping function. As to a general planar light guide, a portion of a light incident from an angle is refracted into the light guide, and the other portion of the reflected light will be reflected further downward, since there is no other surface, so that the reflected light cannot enter into the light guide. In addition, when the light passing through the main body 1 of the present invention to a solar panel, the impedance of the light wave between the material of the main body 1 and the material of the solar panel is much smaller that the impedance between the air and the material of the solar panel, so that a relatively larger amount of light waves is transmitted and entered into the solar panel, and when the main body 1 is covered onto the solar panel, the power generation efficiency of the solar panel can be improved.

In an experiment of the light trapping function, the main body 1 is covered onto different solar panels (not shown in the figure) which are not encapsulated, and the material, the geometric shape, and the size of the main body 1 are the same as those of the aforementioned droplet bounce experiment, and the experimental design and environment are compliance with standard specifications. The experiment takes place in an environment of an ambient temperature 25° and an average illuminance of sunlight on ground surface (AM1.5, 1000 W/m2), wherein the experiment adopts a voltage of −0.4V˜1V, an increment of 0.02V, a time delay of 200 ms; and each test piece is tested for five times, and an average of the five experiment results is taken.

During the experiment, the power generation efficiency of the solar panel is measured in the aforementioned experimental design and environment, and then the test piece of the main body 1 is attached and covered onto the solar panel. In the same experiment design and environment, the power generation efficiency is measured.

Experiment results show that the microstructure of the present invention can improve the power generation efficiency of a silicon-chip solar panel from 17.8% to 19.2% or improve the power generation efficiency of the dye-sensitized cell solely designed by Department of Optoelectric Physics of National Cheng Kang University from 7.91% to 9.67%. Obviously, the present invention can perform light trapping to improve the solar power generation efficiency. In addition, the main body 1 has the aforementioned self-cleaning ability, so that dust will not be attached onto the surface of the main body easily to maintain good solar power generation efficiency.

In summation of the description above, the technical measures disclosed in the present invention overcome the drawbacks of the prior art and achieve the expected objectives and effects. In addition, the present invention has not been published or disclosed publicly prior to filing the patent application, and the invention complies with the patent application requirements, and is submitted to the Patent and Trademark Office for review and granting of the commensurate patent rights.

While the invention has been described by means of specific embodiments, numerous modifications and variations could be made thereto by those skilled in the art without departing from the scope and spirit of the invention set forth in the claims.

What is claimed is:

1. A multiple function microstructure with lotus and light trapping effects, comprising: a main body, formed by a plurality of triangular walls with the same and different heights and a triangular cross section and arranged apart from one another or staggered with one another, and including a surface layer, a middle layer with zero to plural layers, and a bottom layer arranged sequentially from a high position to a low position bottom; wherein the surface layer is just a straight line, and the middle layer and the surface layer constitute an open or closed space, and the bottom layer and one of the other layers constitute a closed space; and the cross section of the top of the triangular wall is substantially a smooth upwardly convex curve.

2. The multiple function microstructure with lotus and light trapping effects according to claim 1, wherein the main body is made of a transparent and hydrophobic material, so as to provide the lotus and light trapping effects.

3. The multiple function microstructure with lotus and light trapping effects according to claim 1, wherein the main body is made of an oleophobic material, so as to provide an oleophobic effect.

4. The multiple function microstructure with lotus and light trapping effects according to claim 1, wherein the main body surface is coated with layers of different chemical materials as needed.

5. The multiple function microstructure with lotus and light trapping effects according to claim 1, wherein each triangular wall is a linear structure.

6. The multiple function microstructure with lotus and light trapping effects according to claim 1, wherein each triangular wall is a curved structure.

7. The multiple function microstructure with lotus and light trapping effects according to claim 1, wherein the top of each triangular wall is configured with the same height.

8. The multiple function microstructure with lotus and light trapping effects according to claim 1, wherein the top of each triangular wall is configured with a different height.

9. The multiple function microstructure with lotus and light trapping effects according to claim 1, wherein the bottom-layer triangular wall has a pitch smaller than 10 μm.

10. The multiple function microstructure with lotus and light trapping effects according to claim 1, wherein the top of the triangular wall has a cross section in a smooth arc shape.
